(19) United States
(12) Patent Application Publication
(10) Pub. No.: US 2021/0337305 A1
(43) Pub. Date: Oct. 28, 2021

(54) BASS-REFLEX ENCLOSURE

(71) Applicant: Shenzhen Saiyuan Electronics Co., Ltd., Shenzhen (CN)

(72) Inventors: Pinghua HUANG, Shenzhen (CN); Caihong HE, Shenzhen (CN)

(21) Appl. No.: 17/368,067

(22) Filed: Jul. 6, 2021

Related U.S. Application Data
(63) Continuation of application No. PCT/CN2020/073332, filed on Jan. 20, 2020.

(30) Foreign Application Priority Data
Jan. 23, 2019 (CN) 2019201140479

(51) Int. Cl. H04R 1/28; H04R 1/34

(52) U.S. Cl. CPC H04R 1/2819; H04R 1/345; H04R 1/2826

(57) ABSTRACT

A bass-reflex enclosure including a enclosure housing, a speaker, and a bass reflection tube is provided. The bass reflection tube is disposed on the front case or the rear case. The bass reflection tube has an inner opening and an outer opening. The inner opening is located in the enclosure housing, and the outer opening is located outside the enclosure housing. The bass reflection tube includes a tube body arranged at the inner side of the front case or the rear case and a cover plate arranged at the inner side or the outer side of the tube body. The bass-reflex enclosure provided by the present disclosure can not only improve the bass effect well through the set bass reflection tube under a smaller volume, but also has a simple structure and easy installation, and has a good application prospect.

### CROSS REFERENCE TO RELATED APPLICATION

This application is a continuation application of International Application No. PCT/CN2020/073332, filed on Jan. 20, 2020, which further claims the benefit and priority of Chinese Patent Application No. 201920114047.9 filed on Jan. 23, 2019, the disclosure of which is incorporated by reference herein in its entirety as part of the present application.

### TECHNICAL FIELD

The present disclosure relates to the technical field of sound box equipment, and more specifically, to a bass-reflex enclosure.

### BACKGROUND ART

In the prior art, the volume of the popular bass-reflex enclosure is getting smaller and small, and the bass reflection tube needs to be large enough in diameter and length to achieve the effect of raising bass. The size of the existing small bass-reflex enclosure is reduced. However, that diameter and length of the bass reflection tube are not enough, so that the bass effect of the small bass-reflex enclosure is relatively poor, or the diameter and length of the bass reflection tube are increased and lengthened in the existing small bass-reflex enclosure. In the manufacture process, a number of plastic structural components are combined to be manufactured, but the plastic structural components in this manner usually require expensive plastic molds to be molded. In addition, the method for combing the number of plastic structural members causes the assembly process to be more complex, and the time is wasted and the labor cost.

Therefore, the prior art has yet to be improved.

### SUMMARY

In view of the disadvantages of the prior art, it is an object of the present disclosure to provide a bass-reflex enclosure capable of solving the technical problems of poor bass effect, complex structure, and high cost of the conventional small bass-reflex enclosure.

In order to solve the above technical problems, the present disclosure adopts the following technical scheme.

A bass-reflex enclosure including an enclosure housing, a speaker and a bass reflection tube is provided. The enclosure housing includes a front case and a rear case. The bass reflection tube is provided on the front case or the rear case. The bass reflection tube has an inner opening and an outer opening. The inner opening is located in the enclosure housing, and the outer opening is located outside the enclosure housing. The bass reflection tube includes a tube body and a cover plate for sealing a side of the tube body. The tube body is provided inside the front case or the rear case, and the cover plate is provided inside or outside the tube body.

As an improvement of the present disclosure, the enclosure housing is further provided with a sealing partition for separating the enclosure housing into two independent left enclosure housing and right enclosure housing. The left enclosure housing and the right enclosure housing are both equipped with speakers. The number of the bass reflection tube is two. The bass reflection tube includes a left bass reflection tube and a right bass reflection tube. Outer openings of the left bass reflection tube and the right bass reflection tube are respectively located at the front side of the left enclosure housing and the right enclosure housing.

As an improvement of the present disclosure, the left bass reflection tube is configured to pass through the sealing partition. The inner opening of the left bass reflection tube is located in the right enclosure housing, and the right bass reflection tube is configured to pass through the sealing partition. The inner opening of the right bass reflection tube is located in the left enclosure housing.

As an improvement of the present disclosure, the speaker is mounted on the front case. The bass reflection tube tube is provided on the front case, and the tube body is provided on the inside of the front case. The outer opening is provided at the front side of the enclosure housing and is aligned with the direction of the speaker.

As a further improvement of the present disclosure, the bass-reflex enclosure further includes a mesh cover. The mesh cover is provided on the front case and covers the cover plate of the speaker and/or the bass reflection tube.

As a further improvement of the present disclosure, the bass-reflex enclosure further includes a gasket made of soft material and arranged between the mesh cover and the cover plate of the bass reflection tube.

As a further improvement of the present disclosure, the pipe body is provided with a step, and the cover plate is provided on the pipe body and fitted with the step.

As a further improvement of the present disclosure, the cover plate is bonded with the tube body through a back gel or an adhesive.

As a further improvement of the present disclosure, the cover plate is made of a two-layer material. The outer side of the cover plate is made of a hard material, and the inner side of the cover plate is made of soft material.

As a further improvement of the present disclosure, the pipe body is a bent pipe body.

As a further improvement of the present disclosure, the pipe body is a U-shaped pipe body, and the cover plate is fitted with the U-shaped pipe body.

As a further improvement of the present disclosure, the outlet of the pipe body is bent inward in the a depth direction of the pipe body.

As a further improvement of the present disclosure, an inner opening and/or an outer opening of the bass reflection tube is bell mouth shaped.

As a further improvement of the present disclosure, the outer side of the tube body is combined with the cover plate with a dovetail slot, and the dovetail slot is provided at the opening of the tube body. The shape of the dovetail slot is consistent with the bell mouth shaped opening in the tube body.

As a further improvement of the present disclosure, the speaker is mounted on the front case; the bass reflection tube is provided on the rear case the tube body is provided inside the rear case; and the outer opening is arranged at the side or rear of the enclosure housing.

Compared with the prior art, the present disclosure provides a bass-reflex enclosure including an enclosure housing, a speaker and a bass reflection tube. The enclosure housing includes a front case and a rear case. The bass reflection tube is provided on the front case or the rear case. The bass reflection tube has an inner opening and an outer opening. The inner opening is located in the enclosure housing, and the outer opening is located outside the enclosure housing. The bass reflection tube includes a tube body and a cover plate for sealing a side of the tube body. The tube body is provided inside the front case or the rear case, and the cover plate is provided inside or outside the tube body and being capable of being in a smaller volume by a bass reflection tube, which can not only improve the bass effect, but also simplify the existing manufacturing process, save the cost, have simple structure and easy installation, and have a good application prospect.

### BRIEF DESCRIPTION OF THE DRAWINGS

FIG. 1 is a structural diagram of a bass-reflex enclosure provided by the present disclosure.

FIG. 2 is a structural diagram of the bass-reflex enclosure provided by the present disclosure with a cover plate.

FIG. 3, FIG. 4 and FIG. 5 are structural diagrams of the bass reflection tube of the bass-reflex enclosure provided by the present disclosure.

FIG. 6 and FIG. 7 are internal structure diagrams of the bass-reflex enclosure provided by the present disclosure;

FIG. 8 is a structural diagram of the bass-reflex enclosure provided by the present disclosure with a mesh cover.

### DETAILED DESCRIPTION OF THE EMBODIMENTS

In order to make the objects, technical solutions and advantages of the present disclosure more clearly, the present disclosure will be described in further detail with reference to the drawings and embodiments. It is to be understood that the specific embodiments described herein are for the purpose of explaining the disclosure only and are not intended to limit the disclosure.

It should be noted that when a component is referred to as being “mounted to,” “fixed to” or “disposed at” another component, it may be directly provided on the other components or there may be an intermediate component at the same time. When a component is described as “connected” to another component, it may be directly connected to another components or there may be an intermediate component at the same time.

It should be noted that, the left, right, top, bottom, etc. terms in the embodiments of the present disclosure are only relative concepts to each other or refer to the normal use state of the product, and should not be considered as limiting.

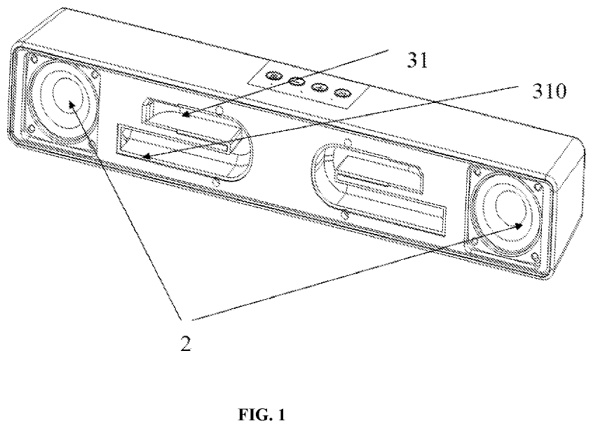

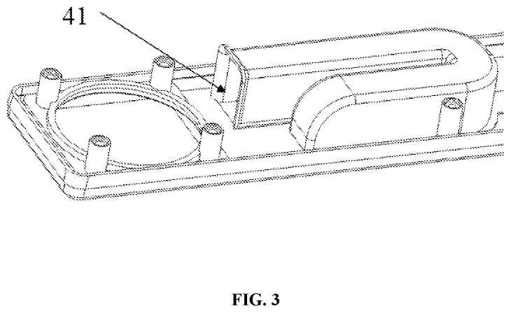

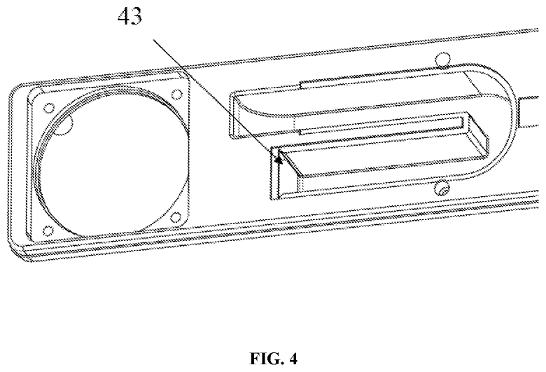

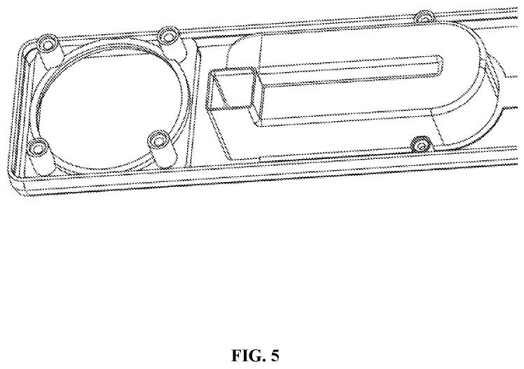

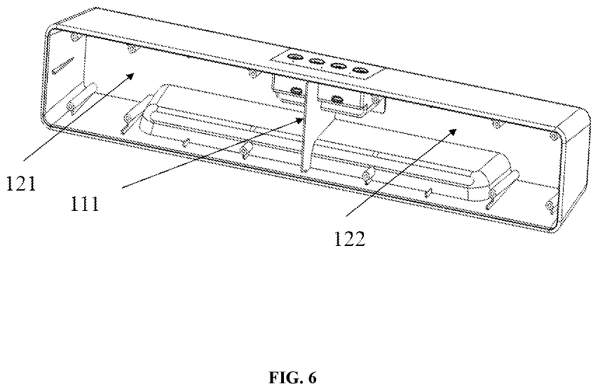

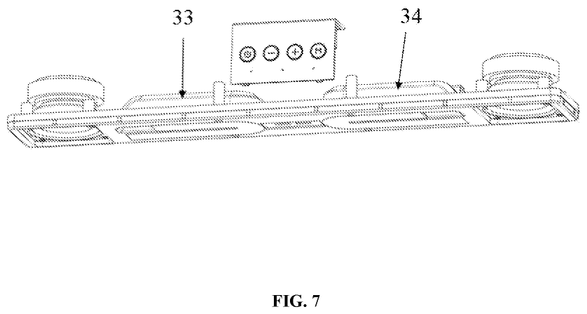

Referring to FIGS. 1-7, a bass-reflex enclosure provided in a preferred embodiment of the present disclosure includes a enclosure housing (not shown in the drawings), a speaker 2 and a bass reflection tube 3. The enclosure housing includes a front case 11 and a rear case 12. The bass reflection tube 4 is disposed on the front case 11 or the rear case 12, and the bass reflection tube 4 has an inner opening 41 and an outer opening 42, respectively. The inner opening 41 is located inside the enclosure housing. The outer opening 42 is located outside the enclosure housing, and the bass reflection tube 3 includes a tube body 31 and a cover plate 32 for sealing the side of the tube body. The tube body 31 is disposed inside the front case 11 or the rear case 12, and the cover plate 32 is disposed inside or outside the tube body 31.

In this embodiment, the speaker 2 and the bass reflection tube 3 are both arranged on the enclosure housing, which not only facilitates the installation, but also simplifies the installation structure. Specifically, the bass reflection tube 3 is disposed on the front case 11, and alternatively, may be disposed on the rear case 12 as long as the bass reflection tube 3 can be structurally connected. Specifically, the cover plate 32 and the tube body 31 form a bass reflection tube 3 with two openings. The two openings are respectively an inner opening 41 and an outer opening 42. The inner opening 41 is located inside the enclosure housing. The outer opening 42 is located at the outer side of the enclosure housing. The bass reflection tube 3 can be enlarged by increasing the width and depth of the tube body 31, and the bass reflection tube can be lengthened by extending the tube body 31 and the cover plate 32 in order to achieve the effect of raising the bass-reflex enclosure bass.

Further, referring to FIGS. 1-7, the enclosure housing is provided with a sealing partition 111 for separating the enclosure housing into two independent chambers, i.e. the left enclosure housing 121 and the right enclosure housing 122. Two speakers 2 are respectfully installed in the left enclosure housing 121 and the right enclosure housing 122, and the bass reflection tube 3 includes a left bass reflection tube 33 and a right bass reflection tube 34. The outer openings of the left bass reflection tube 33 and the right bass reflection tube 34 are respectively located in front of the left enclosure housing 121 and the right enclosure housing 122.

Specifically, the sealing partition plate 111 is arranged to separate the enclosure housing into two independent enclosure housings, thereby improving the utilization rate of the space, and at the same time, increasing the number, length and height of the bass reflection tube 3, which further improves the bass sound quality, and at the same time, the structure is simple, easy to be assembled and disassembled, not easy to be damaged.

Further, the left bass reflection tube body 31 passes through the sealing partition 111. The inner opening of the left bass reflection tube 33 is located in the right enclosure housing 122. The right bass reflection tube 34 passes through the sealing partition 111. The inner opening of the right bass reflection tube 34 is located in the left enclosure housing 121. The inner opening of the right bass reflection tube 34 is sleeved and connected to each other, which not only saves the installation space, but also makes the connection more tight and stable.

Further, as an embodiment of the present disclosure, the speaker 2 is mounted on the front case 11. The bass reflection tube 3 is also disposed on the front case 11. The tube body 31 is disposed on the inner side of the front case 11. The outer opening 42 is arranged at the front side of the enclosure housing in the same direction as the speaker 2, so that the bass effect can be greatly improved.

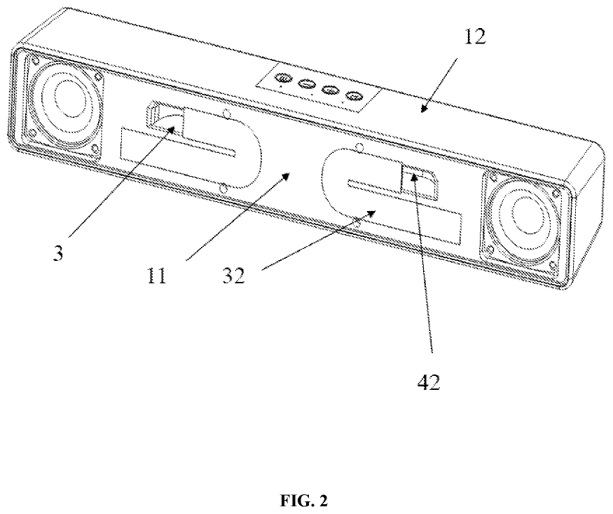

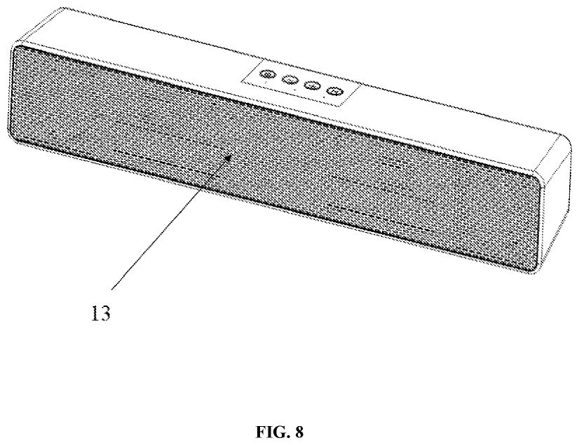

Further, referring to the FIG. 2 and FIG. 8, the bass-reflex enclosure further includes a mesh cover 13 covering the outer side of the front case 11, the cover plate 32 of the speaker 2 and/or the bass reflection tube. A mesh cover 13 is provided on the outer side of the front case 11 to conceal the mounting structure on the outer side of the enclosure housing 1, so that the whole structure looks clean and beautiful.

Further, the bass-reflex enclosure further comprises a gasket (not shown in the figures) made of soft material and arranged between the mesh cover 13 and the cover plate 32 of the bass reflection tube, so as to play an anti-vibration role.

In a further embodiment, referring to FIGS. 1 and 2, the pipe body 31 is provided with a step 310. The cover 32 is disposed on the pipe body 31 and is adapted to the step 310. The step 310 allows the cover plate 32 to be positioned more accurately and quickly during installation.

Furthermore, the cover plate 32 is bonded to the tube body 31 by a back glue or an adhesive, and the cover plate 32 is bonded to the tube body 31 by a back glue or an adhesive in order to ensure the stability and firmness of the connection. In addition, the disclosure can make the connection more stable, and the process is simple, and the bass reflection tube can be sealed well.

Furthermore, the cover plate 32 is made of a two-layer material. The outer side of the cover plate 32 is made of a hard material, and the inner side of the cover plate 32 is made of a soft material. The cover plate 32 and the tube body 31 can be more tightly fitted without air leakage, and the process is simple.

Furthermore, the pipe body 31 is designed to be bent, and the cover plate 32 is adapted to the pipe body 31, and covers the pipe body 31. The bass reflection tube can be designed with an L-shape, a U-shape, an S-shape, a spiral shape or other bending shapes. The bass reflection tube 3 can be lengthened so as to achieve the effect of raising the bass of the bass-reflex enclosure. In addition, that bass reflection tube 3 doe not need to be made in a combination manner of a number of plastic structural member, and can only be made into L-shape, U-shape, S-shape, spiral shape and other shapes by using a simple mold as required. The production is convenient, the volume is reduced and the production cost is reduced under the premise of not losing the bass sound quality effect.

Further, referring to FIG. 5, the outlet of the tube body 31 is bent inward in the depth direction of the tube, that is, the thickness direction of the cover plate 32. Thus, the effect of raising the bass of the bass-reflex enclosure is achieved, and the process is simple, and the production cost is reduced by using a simple mold.

Further, the inner opening and/or the outer opening of the bass reflection tube 3 is bell mouth shaped. The shape of the bell mouth can reduce the air flow sound at the outlet of the bass reflection tube 3, thereby further improving the sound quality of the bass-reflex enclosure.

Further, referring to FIG. 4, the outer side of the tube body 31 and the cover plate 32 are combined with a dovetail slot 43. The dovetail slot 43 is disposed at an inner opening of the tube body 31. The shape of the dovetail slot 43 is consistent with the shape of the bell mouth opening in the tube body 31, and the configuration only needs to be made by using a simple mold, thereby reducing the production cost.

Further, as a further embodiment of the present disclosure, the speaker 2 is mounted on the front case 11. The bass reflection tube 3 is disposed on the rear case 12. The tube body is disposed on the inner side of the rear case 12. The outer opening 42 is located at the side or rear of the sound cavity case, which effectively utilizes the space and further reduces the volume of the bass-reflex enclosure.

In summary, the present disclosure provides a bass-reflex enclosure including a enclosure housing, a speaker, and a bass reflection tube. The enclosure housing includes a front case and a rear case. The bass reflection tube is disposed on the front case or the rear case. The bass reflection tube is respectively provided with an inner opening and an outer opening. The inner opening is located inside the enclosure housing, and the outer opening is located outside the enclosure housing. The bass reflection tube includes a tube body disposed inside the front case or the rear case and a cover plate for sealing the sides of the tube body. The cover plate being disposed inside or outside the tube body and being capable of being in a smaller volume. The bass reflection tube can not only improve the bass effect, but also simplify the existing manufacturing process, save the cost, and the structure is simple and easy to install, thus having a good application prospect.

The bass-reflex enclosure of the present disclosure also has the characteristics of simple structure, convenient installation, long service life, stable and reliable use.

It is to be understood that, to those of ordinary skill in the art, equivalent substitutions or changes may be made in accordance with the technical solutions of the present disclosure and the disclosed concepts thereof, all such changes or substitutions should fall within the scope of the claims appended to this disclosure.

What is claimed is:

1. A bass-reflex enclosure comprising an enclosure housing, a speaker and a bass reflection tube; wherein the enclosure housing comprises a front case and a rear case; the bass reflection tube is provided on the front case or the rear case; the bass reflection tube has an inner opening and an outer opening; the inner opening is located in the enclosure housing, and the outer opening is located outside the enclosure housing; the bass reflection tube comprises a tube body and a cover plate for sealing a side of the tube body; the tube body is provided inside the front case or the rear case, and the cover plate is provided inside or outside the tube body.

2. The bass-reflex enclosure of claim 1, wherein the enclosure housing is further provided with a sealing partition for separating the enclosure housing into two independent left enclosure housing and right enclosure housing; the left enclosure housing and the right enclosure housing are both equipped with speakers; the number of the bass reflection tube is two; the bass reflection tube comprises a left bass reflection tube and a right bass reflection tube; outer openings of the left bass reflection tube and the right bass reflection tube are respectively located at the front side of the left enclosure housing and the right enclosure housing.

3. The bass-reflex enclosure of claim 2, wherein the left bass reflection tube is configured to pass through the sealing partition, the inner opening of the left bass reflection tube is located in the right enclosure housing, and the right bass reflection tube is configured to pass through the sealing partition; and the inner opening of the right bass reflection tube is located in the left enclosure housing.

4. The bass-reflex enclosure of claim 1, wherein the speaker is mounted on the front case, the bass reflection tube tube is provided on the front case, and the tube body is provided on the inside of the front case, the outer opening is provided at the front side of the enclosure housing and is aligned with the direction of the speaker.

5. The bass-reflex enclosure of claim 4, wherein the bass-reflex enclosure further comprises a mesh cover; the mesh cover is provided on the front case and covers the cover plate of the speaker and/or the bass reflection tube.

6. The bass-reflex enclosure of claim 5, wherein the bass-reflex enclosure further comprises a gasket made of soft material and arranged between the mesh cover and the cover plate of the bass reflection tube.

7. The bass-reflex enclosure of claim 1, wherein the pipe body is provided with a step, and the cover plate is provided on the pipe body and fitted with the step.

8. The bass-reflex enclosure of claim 1, wherein the cover plate is bonded with the tube body through a back gel or an adhesive.

9. The bass-reflex enclosure of claim 8, wherein the cover plate is made of a two-layer material; the outer side of the cover plate is made of a hard material, and the inner side of the cover plate is made of soft material.

10. The bass-reflex enclosure of claim 1, wherein the pipe body is a bent pipe body.

11. The bass-reflex enclosure of claim 10, wherein the pipe body is a U-shaped pipe body, and the cover plate is fitted with the U-shaped pipe body.

12. The bass-reflex enclosure of claim 10, wherein the outlet of the pipe body is bent inward in the a depth direction of the pipe body.

13. The bass-reflex enclosure of claim 1, wherein an inner opening and/or an outer opening of the bass reflection tube is bell mouth shaped.

14. The bass-reflex enclosure of claim 13, wherein the outer side of the tube body is combined with the cover plate with a dovetail slot, and the dovetail slot is provided at the opening of the tube body; and the shape of the dovetail slot is consistent with the bell mouth shaped opening in the tube body.

15. The bass-reflex enclosure of claim 1, wherein the speaker is mounted on the front case; the bass reflection tube is provided on the rear case the tube body is provided inside the rear case; and the outer opening is arranged at the side or rear of the enclosure housing.
